(19) United States
(12) Patent Application Publication
(10) Pub. No.: US 2023/0025692 A1
(43) Pub. Date: Jan. 26, 2023

(54) Method for Providing an Explanation Dataset for an AI Module, Computer-Readable Storage Medium, Device and System

(71) Applicant: NEUROCAT GMBH, Berlin (DE)

(72) Inventors: Felix Assion, Berlin (DE); Florens Fabian Gressner, Berlin (DE); Stephan Hinze, Berlin (DE); Frank Kretschmer, Cottbus (DE); Benedikt Julius Wagner, London (GB)

(21) Appl. No.: 17/778,724

(22) PCT Filed: Nov. 19, 2020
(86) PCT No.: PCT/EP20/82749

§ 371 Date: May 20, 2022

(30) Foreign Application Priority Data
Nov. 22, 2019 (DE) 10 2019 131 639.1

(51) Int. Cl. G06K 9/62; G06N 20/00; G06N 5/04

(52) U.S. Cl. CPC G06K 9/6256; G06K 9/6215; G06N 20/00; G06N 5/045

(57) ABSTRACT

Explaining the decisions of AI modules to a user is difficult.

The invention relates to methods for providing an explanation dataset (2) for an AI module (31), the methods comprising:
receiving a user dataset (20) which specifies at least one input dataset (21) of an AI module (31), wherein the AI module (31) is adapted to compute an output dataset (3) for the input dataset (21), wherein the user dataset (20) comprises at least one target specification (25) which specifies a value of a data item (26) in an output dataset (3) of the AI module (31);
loading at least one optimization task (16) which specifies a specific metric (14) and/or a similarity metric (15);
computing at least one solution of the at least one optimization task (16) as an explanation dataset (2) taking the user dataset (20) and the AI module (31) into consideration and applying at least one optimization method (17), wherein the AI module (31) is adapted to compute for the explanation dataset (2) an output dataset (3) which comprises the data item (26) specified by the target specification (25);
providing the explanation dataset (2) for the AI module (31).

### CROSS-REFERENCE TO RELATED APPLICATIONS

The present application is a National Stage of International Application No. PCT/EP2020/082749, filed on Nov. 19, 2020, and titled “Method for providing an explanation dataset for an AI module, computer-readable storage medium, device and system,” which claims priority to German Patent Application No. 102019131639.1, filed Nov. 22, 2019, and titled, “Method for providing an explanation dataset for an AI module, computer-readable storage medium, device and system,” the entirety of each of which is incorporated by reference herein.

### FIELD

The invention relates to a method for providing an explanation dataset for an AI module, a computer-readable storage medium, and a system.

### BACKGROUND

With AI modules, it is possible to perform a classification or a regression for an input dataset. For example, an artificial neural network can be used to determine for each pixel of an image whether it shows skin cancer or not. Furthermore, it is possible to use an AI module to determine, based on customer data of a customer of a bank, whether the customer should receive a loan or not.

AI modules are complex data structures or programs that are trained for a task in a training phase or, in the case of reinforcement learning, during operation. For example, in an artificial neural network, the weights of a plurality of activation functions are determined. In addition, other hyperparameters can be determined, which determine the structure of the artificial neural network. The number of weights/parameters to be learned is very large.

One problem with modern machine learning methods is that the complexity of AI modules is large, making it difficult and in many cases impossible to explain in human-understandable detail why an AI module arrived at a particular output based on an input dataset. Furthermore, it is difficult to explain why a particular input leads to an output and another input leads to the same or a different output.

The inability to explain a decision of the AI module leads to many problems. For example, it is not possible to certify an AI module for use in autonomous driving without a deeper understanding of the decision-making processes.

In addition, regulatory problems exist. For example, at least in the European Union there is a legal regulation according to which it should be possible for a user of an AI module to receive an explanation of a decision made by the AI module.

However, a technical explanation specifying the hyperparameters and weights involved, even if possible, is not satisfactory for a user.

In the publication Wachter, Sandra & Mittelstadt, Brent & Russell, Chris. (2018). Counterfactual Explanations Without Opening the Black Box: Automated Decisions and the GDPR. Harvard Journal of Law & Technology. 31. 841-887, proposes to provide a user of an AI module with an explanation dataset, also called a counterfactual, instead of a technical explanation. The explanation dataset is intended to be substantially the same as the user's input dataset to the AI module, but with such modifications that a desired alternative result is provided by the AI module.

For example, an AI module could be trained to assess whether or not a user should be granted a loan based on, among other things, the user's salary. If the loan is denied to the user, the user could request an explanation for the negative decision.

The foregoing disclosure proposes the general idea of providing the user with an explanation dataset that contains alternative input data for the AI module that would have resulted in a positive loan decision. For example, the alternative explanation dataset could indicate a higher income that would have resulted in a positive loan decision by the AI module.

This methodology can be transferred to any application area. For example, in a medical context, an explanation dataset could contain information on which blood values would have to change in order to obtain a negative diagnosis regarding a disease. In this way, the explanation dataset can also be used to derive behavioral measures that contribute to a healthier lifestyle.

The above-mentioned publication does not contain any mathematical or technical details regarding the idea of a possible implementation for generating an explanation dataset or counterfactuals.

### SUMMARY

It is therefore an object of the invention to provide an explanation dataset for an AI module. In particular, it is further an object of the invention to provide a technical implementation for providing an explanation dataset.

The object is solved by a method according to claim 1, a computer-readable storage medium according to claim 14, a device according to claim 15, and by a system according to claim 17.

The object is solved in particular by methods for providing an explanation dataset for an AI module, comprising:

receiving a user dataset which specifies at least one input dataset of an AI module, wherein the AI module is adapted to compute an output dataset for the input dataset, e.g. by means of a regression and/or classification, wherein the user dataset comprises at least one target specification which specifies a value of a data item in an output dataset of the AI module;

loading at least one optimization task which specifies a specific metric and/or a similarity metric;

computing at least one solution of the at least one optimization task as an explanation dataset taking the user dataset and the AI module into consideration and applying at least one optimization method, wherein the AI module is adapted to compute for the explanation dataset an output dataset which comprises the data item specified by the target specification;

providing the explanation dataset for the AI module.

A core feature of the invention is that the task of finding an explanation dataset is modeled as an optimization task. In this regard, a user may provide a target specification that may represent a desired result for the input dataset after processing by the AI module. The target specification therefore specifies at least one value of a data item in an output dataset of the AI module.

The optimization task specifies a specific metric and a similarity metric, wherein the minimizing of the metrics may, in one embodiment, solve the optimization task. In this regard, the specific metric and the similarity metric may each specify classes of metrics, such that by combining different concrete specific metrics and concrete similarity metrics, a plurality of optimization tasks may be defined, each of which may yield different results when solved. Thus, in one embodiment, the explanation dataset can provide a plurality of different explanations for the input dataset.

Furthermore, it is also possible to solve the at least one optimization task with different optimization methods. Thus, different concrete metrics can be combined with different optimization methods to provide a large number of explanations as an explanation dataset.

In one embodiment, the user dataset may comprise at least one constraint for the at least one optimization task, wherein the optimization method may compute the at least one optimization task considering the at least one constraint of the user dataset.

Thus, it is possible for a user to specify constraints for the optimization task.

In one embodiment, the at least one constraint may comprise an allowance specification, wherein an allowance specification may specify in which feature categories defined by the input dataset the explanation dataset may differ from the input dataset.

With the described embodiment, it is possible for a user to define a kind of blacklist and/or whitelist for feature categories in which the explanation dataset may differ from the input dataset. For example, a user may specify that a salary specified in the input dataset may not be changed. This can be useful for feature categories that cannot be changed. Constraints can thus also specify technical limitations, such as a maximum speed of a vehicle or a maximum voltage value.

In one embodiment, the at least one constraint may include at least one weight, wherein a weight may indicate a preference for changing a feature category of the input dataset in the explanation dataset.

It is thus also possible to use a constraint to identify feature categories that are easier to change than others. Thus, positive and also negative weights are conceivable. For example, a customer of a bank can change his current employment more easily than his educational background.

In one embodiment, the at least one constraint may comprise at least one range specification, wherein the at least one range specification may specify an allowed value range of a feature category of the explanation dataset, in particular a maximum and/or minimum allowed deviation from a value in the input dataset.

With the embodiment described above, it is thus further possible to specify permitted value ranges in the output dataset. This is advantageous, for example, if image data form the input dataset and the data items of the explanation dataset must be limited to certain color values and/or brightness values, e.g. 0 to 255 each for brightness values of a color channel. Also, by limiting the allowed values, it can be achieved that a very strong change of a single data item is prevented.

Overall, by providing constraints that are provided or defined by a user or a provider or operator of an AI module, the solution space of the at least one optimization task can be limited and the user receives only those solutions as an explanation dataset that are relevant to him.

In one embodiment, the explanation dataset may comprise a plurality of variations of the input dataset, each satisfying the at least one constraint.

As indicated above, the explanation dataset may include a variety of variations of the input dataset, which may be generated by a combination of different metrics and optimization methods.

In one embodiment, the method may comprise receiving at least one provider dataset, wherein the provider dataset may comprise at least one constraint for the at least one optimization task, wherein the optimization method may compute the at least one optimization task by taking the at least one constraint of the provider dataset into consideration.

In addition to a user dataset, a provider dataset with constraints can also be received. Thus, certain constraints can be specified by a user of an AI module on the one hand and by a provider or operator of an AI module on the other hand. The user dataset and the operator dataset can be received separately as two different data units or also as part of a single dataset.

In one embodiment, the at least one constraint of the provider dataset may specify an output count, wherein the output count may specify how many variations of the input dataset are computed and included by the explanation dataset.

To make the number of possible variations of the input dataset manageable, the number of variations may be limited. For example, in one embodiment, the number may be limited to the output count. In one embodiment, the output number may indicate the number of optimization tasks to be solved multiplied by the number of optimization methods used. In one embodiment, providing the explanation dataset may comprise filtering, wherein the filtering may comprise limiting the solutions of the at least one optimization task indicated by the explanation dataset.

In one embodiment, the at least one optimization method may comprise a gradient method and/or a Newton method. A gradient method and a Newton method are efficient ways to solve at least one optimization task.

In one embodiment, the specific metric may be minimal if the target specification matches the data item of the output dataset of the AI module, wherein the specific metric may be, for example, a cross entropy and/or a root mean square deviation.

Minimizing the specific metric thus ensures that the result dataset leads to an output of the AI module that matches the target specification. In this context, a cross entropy or even a mean square deviation can be used as a specific metric. Both of these specific metrics are efficient to implement and can be minimized by optimization methods.

In one embodiment, the similarity metric may be formed as an Lp norm, in particular as an L0, L1 and/or L2 metric.

The similarity metric ensures that the explanation dataset is close to the input dataset. The use of a similarity metric and its mathematical optimization, i.e. minimization, by optimization methods has the advantage that a change vector is sparse or comprises low values, for example the minimum number of changed vector values in the case of the L0 metric or the smallest possible root of the sum of squared individual vector values in the case of the L2 metric . This means that the input dataset and the explanation dataset differ only in a few data items, and the respective differences of the data items are purposefully limited. This enables meaningful input comparisons for the AI user or AI operator.

In one embodiment, the at least one optimization task may be represented by the formula

$${min}_{δ} {M}_{sp} ( δ ) + λ {M}_{i m} ( δ ) ,$$

wherein Mₛₚ may denote the specific metric and Mᵢₘ may specify the similarity metric, and δ may be selected from a set of allowable changes in the input dataset.

The above formula can be solved by optimization methods and thus provides an efficient implementation of the optimization tasks. In one embodiment, the set of allowable changes of the input dataset may be determined by at least one or the at least one constraint of the user dataset and/or the provider dataset.

In one embodiment, the method may comprise computing an output dataset using the AI module, wherein the explanation dataset may be used as an input dataset of the AI module.

The method can thus also include the use of the computed explanation dataset by the AI module. This can be used to check whether the explanation dataset leads to the result indicated by the target specification.

The object is further solved in particular by a computer-readable storage medium containing instructions that cause at least one processor to implement a method as described above when the instructions are executed by the at least one processor.

The object is further solved by a device for providing an explanation dataset, comprising:

a receiving unit adapted to receive a user dataset which specifies at least one input dataset of an AI module, wherein the AI module is adapted to compute an output dataset for the input dataset, e.g. by means of a regression and/or classification, wherein the user dataset comprises at least one target specification which specifies a value of a data item in an output dataset of the AI module;

an optimization unit adapted to load an optimization task which specifies a specific metric and/or a similarity metric and further adapted to compute at least one solution of the at least one optimization task as an explanation dataset by taking the user dataset and the AI module into consideration by using at least one optimization method, wherein the AI module is adapted to compute for the explanation dataset an output dataset comprising the data item specified by the target specification;

a providing unit adapted to provide the explanation dataset.

In one embodiment, the device may comprise an AI unit which may be adapted to compute an output dataset, wherein the explanation dataset may be used as an input dataset of the AI module.

In one embodiment, the receiving unit may be configured to receive at least one provider dataset, wherein the provider dataset may comprise at least one constraint for the at least one optimization task, wherein the optimization method may be adapted to compute the at least one optimization task by taking into account the at least one constraint of the provider dataset.

With respect to the computer-readable storage medium and the device, similar or identical advantages result as have already been described in connection with the method described above.

The object is further solved by a system, comprising:

at least one server unit,—comprising in particular a device as described above and a server communication unit;

at least one client unit having a client communication unit, which is adapted to send a request to the server communication unit, in particular via a communication network;

wherein the server communication unit is adapted to provide an application programmable interface adapted to receive a user dataset and transmit an explanation dataset.

Similar or identical advantages result as have already been described in connection with the method and device described above.

It is explicitly stated that all aspects described with regard to the method can be combined with the device and the system.

Further embodiments are apparent from the subclaims.

### DESCRIPTION OF DRAWINGS

In the following, the invention is explained in more detail by means of exemplary embodiments, wherein:

FIG. 1: shows a schematic representation of a system;

FIG. 2: shows a schematic representation of the operation of an AI module with an explanation dataset;

FIG. 3: shows a schematic representation of a device for providing an explanation dataset;

FIG. 4: shows a schematic representation of an optimization unit;

FIG. 5: shows an example of an input dataset;

FIG. 6: shows an example of an explanation dataset;

FIG. 7: shows a schematic representation of a distributed system.

In the following, the same reference number is used for identical or similarly acting parts.

### DETAILED DESCRIPTION

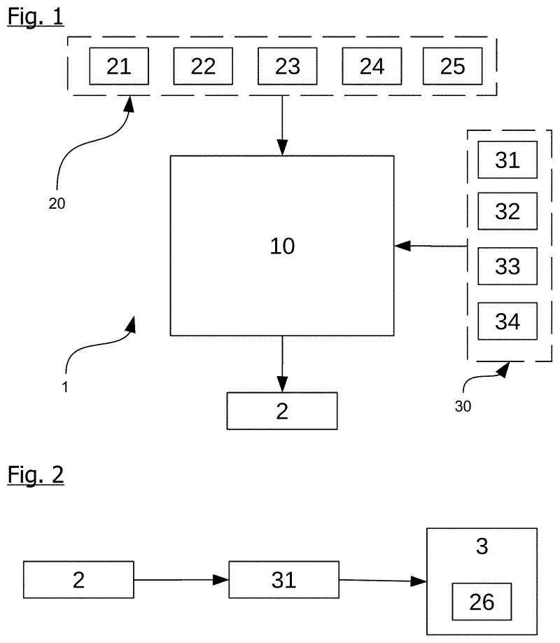

FIG. 1 shows a schematic representation of a system 1 which determines an explanation dataset 2 for a user dataset 20. The system 1 has a device 10 which is adapted to determine the explanation dataset 2 taking into account the user dataset 20 and/or a provider dataset 30. Such a device 10 may also be referred to as a counterfactory 10.

The user dataset 20 has an input dataset 21. The input dataset 21 includes a plurality of data items that form an input to an AI module 31.

In one exemplary embodiment, the input dataset 21 may comprise image data, wherein the data items represent brightness values for pixels. In another exemplary embodiment, the input dataset 21 may comprise characteristics of a bank customer, wherein the data items of the input dataset 21 may indicate, for example, the customer's income, occupation, and age.

The user dataset 20 further has an allowance specification 22 which specifies in which feature categories the explanation dataset 2 may differ from the input dataset 21. Thus, in the exemplary embodiment shown, the user has the ability to specify which features are allowed to change and which are not. The allowance specification 22 may therefore also be regarded as a blacklist or whitelist. For example, in the aforementioned example of a bank customer, the user can specify that the characteristic “age” in the explanation dataset 2 is not allowed to change, since the user has no control over it. The allowance specification 22 may be specified as a vector, wherein the number of dimensions of the vector corresponds to the number of feature categories of the input dataset 21. Each data item of the vector can indicate whether a feature category may be changed.

In addition, the user dataset 20 comprises at least one weight 23, which in the exemplary embodiment shown indicates a preference as to which feature categories in the explanation dataset 2 should preferably be changed or which should not, without blocking them completely. Thus, in the example of the bank customer, the bank customer could indicate that a job change should be more likely than an increase in income in the explanation dataset 2.

Further, in the exemplary embodiment shown, the user dataset 20 includes at least one range specification 24 indicating the ranges within which the variation of a data item of the input dataset 21 is allowed to move. This is useful when certain variations are not possible. For example, in the case of an input dataset 21 specifying image data, the range specification 24 can be used to ensure that a variation of brightness values is again a permissible brightness value, for example, in the range from 0 to 255.

Finally, the user dataset 20 comprises a target specification 25 indicating the desired result to be determined by the AI module 31. For example, in a classification example, the target specification 25 may specify a class. In the case of a regression example, the target specification 25 may specify a particular value. For example, in the example of the bank customer described above, the target specification 25 may indicate that a loan is to be granted.

The provider dataset 30 comprises the AI module 31, which is adapted to perform a classification and/or regression. The AI module 31 may be a software component provided to the device 10. For example, the AI module 31 may be provided as a library of an object-oriented programming language. However, it is also conceivable that the AI module 31 is provided via an application programmable interface (API). In this case, a description of the API is provided to the device 10 as the AI module 31.

The AI module 31 may be any AI module. For example, an AI module trained according to the principles of supervised learning and/or non-supervised learning. For example, the AI module 31 may be an artificial neural network. However, any other implementation of an AI module is conceivable as long as it performs regression and/or classification for an input dataset 21.

In the exemplary embodiment shown, the provider dataset 30 further comprises an allowance specification 32 that, like the allowance specification 22 of the user dataset 20, includes an indication of which feature categories may be modified. The provider of the AI module 31 can thus, for example, prevent changes to certain feature categories from being suggested as explanations, such as a skin color.

Furthermore, the provider dataset 30 has an output count 33 indicating how many different explanations or variations the explanation dataset 2 should comprise. This can ensure that the user only receives a manageable number of explanations.

Further, in the exemplary embodiment shown, the provider dataset 30 includes a deviation specification 34. The deviation specification 34 indicates the minimum degree to which the explanation dataset 2 must deviate from the input dataset 21. For example, a declaration that a loan would have been granted if the salary had been increased by a few cents could have a very negative effect on a customer. It is thus possible to specify that a certain minimum change should be included in the explanation dataset 2.

Overall, the allowance specification 22, the at least one weight 23, the range specification 24, the target specification 25, the allowance specification 32, the output count 33, and the deviation specification 34 define constraints that are considered by the device 10 when providing the explanation dataset 2.

FIG. 2 shows a schematic representation of the result of processing the explanation dataset 2 by an AI module 31. In FIG. 2, it is schematically shown that an explanation dataset 2 provided by a device/counterfactory 10 can be used as an input dataset for an AI module 31 so that it determines an output dataset 3. The output dataset 3 specifies a data item 26, which may specify a regression result or a classification result. In the exemplary embodiment of FIG. 2, the data item 26 corresponds to the target specification 25.

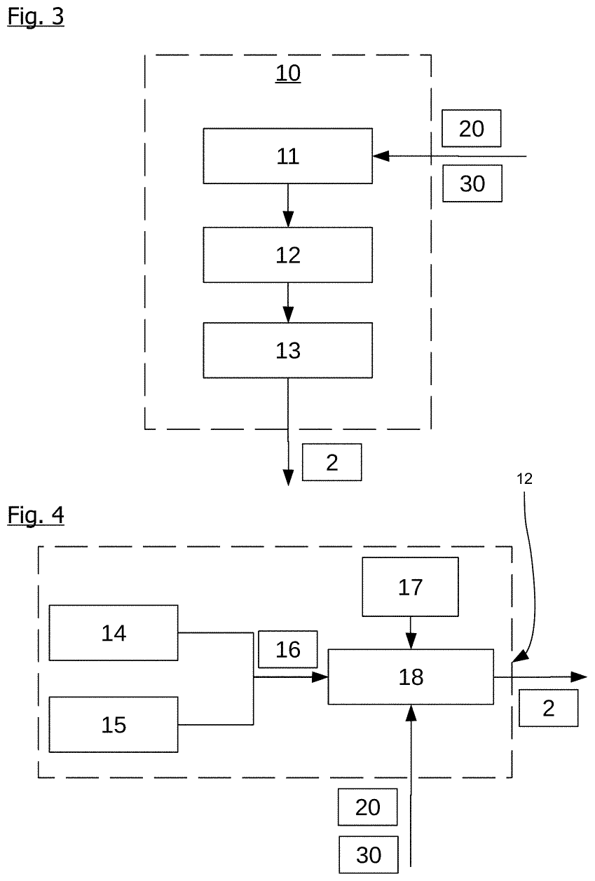

FIG. 3 shows a schematic detailed view of the device/counterfactory 10. The counterfactory 10 receives a user dataset 20 and/or a provider dataset 30 through a receiving unit 11. An optimization unit 12 is adapted to determine an explanation dataset 2 using the user dataset 20 and the provider dataset 30, which is provided by a providing unit 13.

The operation of the optimization unit 12 is shown in more detail in FIG. 4. The optimization unit 12 is adapted to define an optimization task 16 using a specific metric 14 and a similarity metric 15. This optimization task 16 is solved in the solver unit 18 using an optimization method 17 and the constraints specified by the user dataset 20 or provider dataset 30, wherein the solution is provided as an explanation dataset 2.

An optimization task 16 is given by the formula:

$${min}_{δ} {M}_{s p} ( δ ) + λ {M}_{i m} ( δ ) ,$$

wherein Mₛₚ indicates the specific metric 14 and Mᵢₘ the similarity metric 15, and δ is selected from the set of allowable changes in the input dataset 21.

A plurality of optimization tasks 16 can also be determined by choosing different specific metrics. For example, the specific metric 14 can be formed as a cross entropy or as a mean square deviation. The similarity metric 15 can be formed as L0, L1 or as L2 norm.

Thus, many optimization tasks 16 can be defined by combining the different metrics. For example, a first optimization task can use the cross entropy as specific metric 14 and the L0, L1 or as L2 norm as similarity metric 15. A second optimization task may use the mean square deviation as specific metric 14 and the L0, L1 or as L2 norm as similarity metric 15.

By combining different concrete metrics as specific metric 14 and similarity metric 15, respectively, different possible explanations encompassed by the explanation dataset 2 are computed by solving the formula shown above.

Furthermore, different optimization methods 17 can additionally or alternatively be used to solve the optimization tasks 16 so that an even larger number of explanations can be determined to be provided as an explanation dataset 2.

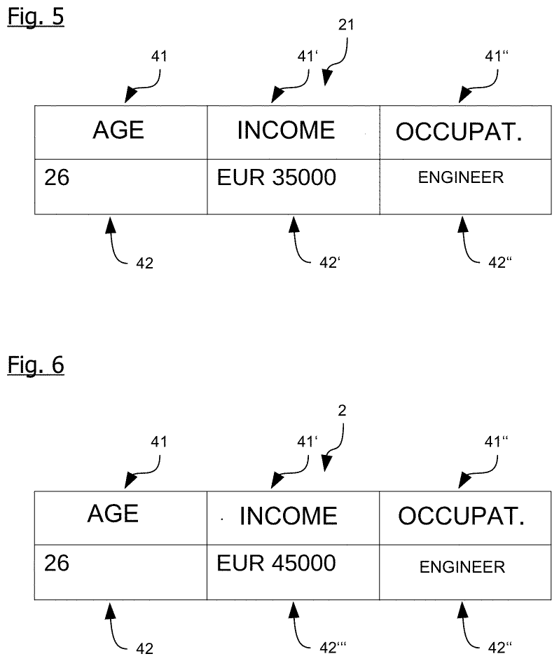

FIGS. 5 and 6 show an example of an input dataset 21 and an explanation dataset 2 for a customer of a bank who wishes to obtain a loan. With the input dataset 21 shown, an AI module 31 determines that the customer will not receive a loan. The AI module 31 thus performs a classification. The input dataset 21 includes the feature categories AGE 41, INCOME 41′, and OCCUPATION 41″. Each of the characteristic categories 41, 41′, 41″ is assigned a value 42, 42′, 42″.

FIG. 6 shows an explanation dataset 2 provided by the device/counterfactory 10. A target specification 25 is passed to the device 10 as part of the user dataset 20, such that the classification by the AI module 31 should result in a loan being granted by modifying the data item 42, 42′, 42″. As a constraint, it is passed to the device/counterfactory 10 as an allowance specification 22 that only the data items of the feature categories INCOME 41′ and OCCUPATION 41″ may be modified.

The explanation dataset 2 is essentially the same as the input dataset 21. Only in the characteristic category INCOME 41′ is the value changed. The user thus receives with the explanation dataset 2 a value for the income which is necessary to obtain a classification by the AI module 31 with otherwise unchanged characteristics, so that the loan is granted.

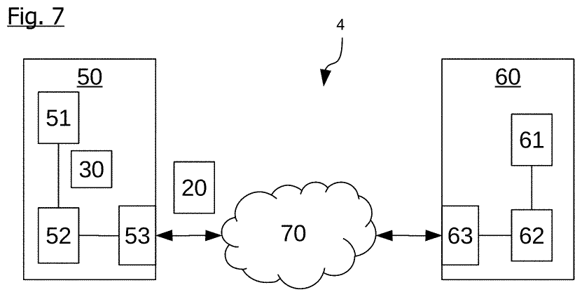

FIG. 7 shows a distributed system 4 that includes a server 50 and a client 60. The server 50 and the client 60 can communicate via a communication network 70, such as the Internet. For this purpose, the client 60 has a client communication interface 63 communicatively connected to a client computer unit 62. The client 60 further comprises a client storage unit 61 adapted to store an input dataset 21.

The server 50 includes a server communication interface 53 communicatively connected to a server computer unit 52. The server computer unit 52 is adapted to execute a program that implements the counterfactory 10.

In the exemplary embodiment shown, the functionality of the counterfactory 10 is provided by means of an API via the server communication interface 53. This means that the client 60 is adapted to transmit a user dataset 20 to the server 50 or the server communication interface 53 via an API call. The server 50 or server computer unit 52 loads a provider dataset 30 from a server storage unit 51. Additionally or alternatively, the server 50 may receive the provider dataset 30 from a second client via the server communication interface 53.

The server computer unit 52 is further adapted to determine an explanation dataset 2 in consideration of the user dataset 20 and the provider dataset 30, and to transmit the explanation dataset 2 to the client 60 via the server communication interface 53.

By using an API it is also possible to enable so-called continuous auditing. This means that the function of the AI module 31 can be checked at any time.

In one exemplary embodiment, it is also possible for the server 50 to execute the AI module 31 and store the results, i.e., the respective output datasets 3. A user or client 60 may then query an explanation dataset 2 at a later time. In this context, it is optionally possible that a state of the AI module 31 used is also stored in the server memory unit 51 for the respective output datasets 3, so that different versions of the AI module 31 can be traced over time. It may be advantageous to store a hash value for the state of the AI module 31.

### LIST OF REFERENCE SIGNS

1 System
2 Explanation dataset
3 Output dataset
4 Distributed system
10 Fixture/Counterfactory
11 Receiving unit
12 Optimization unit
13 Providing unit
14 Specific metric
15 Similarity metric
16 Optimization task
17 Optimization method
18 Solver
20 User dataset
21 Input dataset
22 Allowance specification
23 Weight
24 Range specification
25 Target specification
26 Data item
30 Provider dataset
31 AI module
32 Allowance specification/Whitelist
33 Output count
34 Deviation specification
41, 41′, 41″ Feature category
42, 42′, 42′,42′″ Data item
50 Server
51 Server storage unit
52 Server computer unit
53 Server communication interface/API
60 Client
61 Client storage unit
62 Client computer unit
63 Client communication interface
70 Communication network

1. A method for providing an explanation dataset for an AI module, the method comprising:
receiving a user dataset specifying at least one input dataset of an AI module, wherein the AI module is adapted to compute an output dataset for the input dataset using at least one of a regression and a classification, wherein the user dataset comprises at least one target specification specifying a value of a data item in an output dataset of the AI module;
loading at least one optimization task specifying a specific metric and/or a similarity metric;
computing at least one solution of the at least one optimization task as an explanation dataset, based on the user dataset and the AI module, by at least applying at least one optimization method, wherein the AI module is adapted to compute for the explanation dataset an output dataset comprising the data item specified by the target specification; and
providing the explanation dataset for the AI module.

2. The method of claim 1, wherein the user dataset comprises at least one constraint for the at least one optimization task, wherein the optimization method computes the at least one optimization task based on the at least one constraint of the user dataset.

3. The method of claim 2, wherein the at least one constraint comprises an allowance specification, wherein the allowance specification specifies in which feature categories defined by the input dataset the explanation dataset differs from the input dataset.

4. The method of claim 2, wherein the at least one constraint comprises at least one weight, wherein a weight specifies a preference for a change of a feature category of the input dataset in the explanation dataset.

5. The method of claim 2, wherein the at least one constraint comprises at least one range specification, wherein the at least one range specification specifies a permitted value range of a feature category of the explanation dataset, wherein the permitted value range includes a maximum and/or minimum permitted deviation from a value in the input dataset.

6. The method of claim 2, wherein the explanation dataset comprises a plurality of variations of the input dataset, each satisfying the at least one constraint.

7. The method of claim 1, further comprising receiving at least one provider dataset, wherein the provider dataset comprises at least one constraint for the at least one optimization task, and wherein the optimization method computes the at least one optimization task based on the at least one constraint of the provider dataset.

8. The method of claim 7, wherein the at least one constraint of the provider dataset specifies an output count, and wherein the output count specifies how many variations of the input dataset are computed and comprised by the explanation dataset.

9. The method of claim 1, wherein the at least one optimization method comprises a gradient method and/or a Newton method.

10. The method of claim 1, wherein the specific metric is minimal if the target specification matches the data item of the output dataset of the AI module, and wherein the specific metric is formed as cross entropy and/or as mean square deviation.

11. The method of claim 1, wherein the similarity metric is adapted as an Lpnorm including an L0, L1 and/or L2 metric.

12. The method of claim 2, wherein the optimization task is given by the formula
$${min}_{δ} {M}_{sp} ( δ ) + λ {M}_{i m} ( δ ) ,$$
wherein Mₛₚ specifies the specific metric and Mᵢₘ specifies the similarity metric, and δ is selected from a set of the allowable changes of the input dataset.

13. The method of claim 1, further comprising-computing an output dataset using the AI module, wherein the explanation dataset is used as an input dataset of the AI module.

14. A computer-readable storage medium containing instructions, which when executed by at least one processor, result in operations comprising:
receiving a user dataset specifying at least one input dataset of an AI module, wherein the AI module is adapted to compute an output dataset for the input dataset using at least one of a regression and a classification, wherein the user dataset comprises at least one target specification specifying a value of a data item in an output dataset of the AI module;
loading at least one optimization task specifying a specific metric and/or a similarity metric;
computing at least one solution of the at least one optimization task as an explanation dataset, based on the user dataset and the AI module, by at least applying at least one optimization method, wherein the AI module is adapted to compute for the explanation dataset an output dataset comprising the data item specified by the target specification; and
providing the explanation dataset for the AI module.

15. A device for providing an explanation dataset, comprising:
a receiving unit adapted to receive a user dataset specifying at least one input dataset of an AI module, wherein the AI module is adapted to compute an output dataset for the input dataset using at least one of a regression and a classification, wherein the user dataset comprises at least one target specification specifying a value of a data item in an output dataset of the AI module;
an optimization unit adapted to load an optimization task specifying a specific metric and/or a similarity metric and further adapted to compute at least one solution of the at least one optimization task as an explanation dataset, based on the user dataset and the AI module, using at least one optimization method, wherein the AI module is adapted to compute for the explanation dataset an output dataset comprising the data item specified by the target specification; and
a providing unit adapted to provide the explanation dataset.

16. The device of claim 14, further comprising: an AI unit adapted to compute an output dataset, wherein the explanation dataset is used as an input dataset of the AI module.

17. A system, comprising:
at least one server unit, comprising the device of claim 15 and a server communication interface; and
at least one client unit having a client communication interface, adapted to send a request to the server communication interface, via a communication network;
wherein the server communication interface is adapted to provide an application programmable interface adapted to receive a user dataset and transmit an explanation dataset.
